(19) United States
(12) Patent Application Publication
(10) Pub. No.: US 2015/0247021 A1
(43) Pub. Date: Sep. 3, 2015

(54) POLYGLYCOLIC ACID RESIN COMPOSITION AND METHOD FOR PRODUCING THE SAME

(71) Applicant: KUREHA CORPORATION, Tokyo (JP)

(72) Inventors: Kotaku Saigusa, Tokyo (JP); Satoru Suzuki, Tokyo (JP)

(21) Appl. No.: 14/432,840

(22) PCT Filed: Oct. 9, 2013
(86) PCT No.: PCT/JP2013/077457

§ 371 Date: Apr. 1, 2015

(30) Foreign Application Priority Data
Oct. 11, 2012 (JP) 2012-225653

(51) Int. Cl. C08K 3/36; C08K 3/34; C08J 3/20

(52) U.S. Cl. CPC C08K 3/36; C08J 3/203; C08K 3/34; C08J 2367/04

(57) ABSTRACT

A polyglycolic acid resin (PGA) composition which can be used as a packaging material or a material for a drilling downhole tool (member), the composition containing from 30 to 90 mass % of a PGA and from 70 to 10 mass % of an inorganic filler, wherein the percentage of mass loss of the PGA after immersion in water for 3 hours at a temperature of 120° C. is at least 20% and preferably at least 25%, and the deflection temperature under load is 120° C. or higher; and a method for producing a PGA composition, the method including a step of melt-kneading using an extruder.

### TECHNICAL FIELD

The present invention relates to a polyglycolic acid resin composition containing a polyglycolic acid resin, which is a biodegradable resin, the composition having excellent moldability and mechanical characteristics as well as excellent heat resistance and hydrolyzability, and a method for producing the same.

### BACKGROUND ART

Since aliphatic polyesters such as polyglycolic acid resins (sometimes called “PGA” hereafter) or polylactic acid resins (sometimes called “PLA” hereafter) are degraded by microorganisms or enzymes existing in the natural world such as in soil or in oceans, attention has been focused on these resins as biodegradable polymer materials with a small burden on the environment. In addition, since aliphatic polyesters have biodegradable absorbent properties, they are also used as polymer materials for medical purposes such as surgical sutures or artificial skin.

Among aliphatic polyesters, PGA has excellent mechanical strength as well as excellent gas barrier properties such as oxygen gas barrier properties, carbonic acid gas barrier properties, and water vapor barrier properties or aroma barrier properties. Since PGA has a high melting point and can be melt-molded, the applications of PGA as a biodegradable resin with excellent practicability are expanding, either with PGA alone or as a composite with other resin materials or the like. That is, there are increasing expectations for PGA as a molding material to be molded into products by general-purpose resin molding methods such as injection molding, extrusion molding, compression molding, and blow molding, packaging materials such as food products that are prone to oxidative degradation, packaging materials that can be easily composted and have a small environmental burden, and materials for forming an oil and gas drilling downhole tool or a member thereof for producing petroleum (shale oil or the like) or natural gas (shale gas or the like) by utilizing the strength and degradability of PGA so that it can be left in the ground to biodegrade after use.

However, the molecular weight of PGA sometimes decreases during melt processing due to its hydrolyzability, which forms the foundation of biodegradability, and it is also sometimes difficult to use for long periods of time at a high temperature and high humidity. Further, since PGA has a large crystallization rate, irregularities may arise in the thickness of the molded product, and when performing molding processing as a composite with other thermoplastic resins, there may be problems related to the molding process or the appearance of the product such as difficulty with stretch molding.

A biodegradable resin composition consisting of a biodegradable resin, a thermoplastic elastomer, and an inorganic filler is disclosed in Patent Document 1 as a means for improving the heat resistance of a biodegradable resin, and it is described that this biodegradable resin composition has improved toughness and heat resistance. Examples of biodegradable resins in Patent Document 1 include polylactic acid (PLA), polyethylene succinate, polybutylene succinate, polybutylene succinate adipate, polyglycolic acid (PGA), hydroxyalkanoate-based polymers including poly(-hydroxybutylate), poly(-hydroxyvalerate), poly(-hydroxycaproate), poly(-hydroxyheptanoate), and poly(hydroxybutylate-co-hydroxyvalerate), (poly(hydroxyester-ether)-based polymers, or poly(propylene carbonate). However, the only biodegradable resin that is specifically used is PLA, and the heat resistance of a PLA composition is limited to a heat distortion temperature of from 93.7 to 114° C.

Therefore, there has been a demand for a PGA composition that can be used as a molding material in a general-purpose resin molding method, a packing material for food products or other products, a packaging material with a small environmental burden, and a material for forming an oil and gas drilling downhole tool or a member thereof, the composition having excellent moldability and mechanical characteristics as well as excellent heat resistance and hydrolyzability.

### CITATION LIST

### Patent Document

Patent Document 1: Japanese Unexamined Patent Application Publication No. 2008-63577A

### SUMMARY OF INVENTION

### Technical Problem

The problem of the present invention is to provide a PGA composition that can be used as a molding material in a general-purpose resin molding method, a packing material for food products or other products, a packaging material with a small environmental burden, and a material for forming an oil and gas drilling downhole tool or a member thereof for producing petroleum (shale oil or the like) or natural gas (shale gas or the like), the composition containing PGA serving as a biodegradable resin having excellent moldability and mechanical characteristics as well as excellent heat resistance and hydrolyzability.

### Solution to Problem

As a result of conducting dedicated research to achieve the object described above, the present inventors discovered a PGA composition having excellent heat resistance and hydrolyzability and a method for producing the PGA composition, thereby completing the present invention.

The present invention thus provides a PGA composition containing from 30 to 90 mass % of a PGA and from 70 to 10 mass % of an inorganic filler, wherein the percentage of mass loss of the polyglycolic acid resin after immersion in water for 3 hours at a temperature of 120° C. is at least 20%, and the deflection temperature under load is 120° C. or higher.

The present invention provides the following inventions (1) to (5) as embodiments.

(1) The PGA composition further containing another biodegradable resin.

(2) The PGA composition, wherein the other biodegradable resin is PLA.

(3) The PGA composition, wherein the amount of PGA is at least 70 parts by mass when the total of the PGA and the other biodegradable resin is defined as 100 parts by mass.

(4) The PGA composition, wherein the inorganic filler is at least one type selected from silicon oxide, silicates, carbonates, sulfates, clay minerals, inorganic fibrous fillers, and inorganic whisker-like fillers.

(5) The PGA composition containing two or more types of inorganic fillers.

(6) The PGA composition for a downhole tool or a member thereof.

In addition, the present invention provides a method for producing the PGA composition including a step for melt-kneading a PGA and an inorganic filler using an extruder, and a method for producing the PGA composition by supplying PGA from a main feed port and an inorganic filler from at least a side feed port to the extruder. Further, the present invention provides a method for producing the PGA composition by supplying an inorganic filler to an extruder from a main feed port and a side feed port. In addition, the present invention provides a downhole tool or a member thereof formed from the PGA composition.

### Advantageous Effects of Invention

The present invention is a PGA composition containing from 30 to 90 mass % of a PGA and from 70 to 10 mass % of an inorganic filler, wherein the percentage of mass loss of the polyglycolic acid resin after immersion in water for 3 hours at a temperature of 120° C. is at least 20%, and the deflection temperature under load is 120° C. or higher. This yields the effect of providing a PGA composition that can be used as a molding material in a general-purpose resin molding method, a packing material for food products or other products, a packaging material with a small environmental burden, and a material for forming an oil and gas drilling downhole tool or a member thereof, the composition containing PGA serving as a biodegradable resin having excellent moldability and mechanical characteristics as well as excellent heat resistance and hydrolyzability, and a downhole tool or member thereof formed from the PGA composition.

In addition, the present invention is a method for producing the PGA composition including a step for melt-kneading a PGA and an inorganic filler using an extruder, which yields the effect that the PGA composition can be produced easily.

### DESCRIPTION OF EMBODIMENTS

1. Polyglycolic Acid Resin

The PGA contained in the PGA composition of the present invention refers not only to homopolymers of glycolic acid consisting of repeating units of glycolic acid represented by the formula: (—O—CH₂—CO—) (including ring-opened polymers of glycolides as bimolecular cyclic esters of glycolic acid), but also to polyglycolic acid copolymers (PGA copolymers) containing at least 70 mass % of the repeating units of glycolic acid described above. A PGA can be synthesized by dehydrative polycondensation of a glycolic acid serving as an □-hydroxycarboxylic acid. In order to efficiently synthesize a high-molecular weight PGA, synthesis is performed by performing ring-opening polymerization on a glycolide, which is a bimolecular cyclic ester of glycolic acid.

Examples of comonomers for providing a PGA copolymer together with the aforementioned glycolic acid monomers such as glycolides include glycol compounds such as ethylene glycol, propylene glycol, butanediol, heptanediol, hexanediol, octanediol, nonanediol, decanediol, 1,4-cyclohexane dimethanol, neopentyl glycol, glycerin, pentaerythritol, bisphenol A, polyethylene glycol, polypropylene glycol, and polytetramethylene glycol; dicarboxylic acids such as oxalic acid, adipic acid, sebacic acid, azelaic acid, dodecanedioic acid, malonic acid glutaric acid, cyclohexane dicarboxylic acid, terephthalic acid, isophthalic acid, phthalic acid, naphthalene dicarboxylic acid, bis(p-carboxyphenyl)methane, anthracene dicarboxylic acid, 4,4′-diphenyl ether dicarboxylic acid, 5-sodium sulfoisophthalic acid, and 5-tetrabutyl phosphonium isophthalic acid; hydroxycarboxylic acids such as lactic acid, hydroxypropionic acid, hydroxybutyric acid, hydroxyvaleric acid, hydroxycaproic acid, and hydroxybenzoic acid; lactides; lactones such as caprolactone, valerolactone, propiolactone, undecalactone, and 1,5-oxepan-2-one; carbonates such as trimethylene carbonate; essentially equimolar mixtures of aliphatic diols such as ethylene glycol and 1,4-butanediol and aliphatic dicarboxylic acids such as succinic acid and adipic acid or alkyl esters thereof; or two or more types thereof. Polymers of these comonomers can be used as starting raw materials for providing a PGA copolymer together with glycolic acid monomers such as the glycolides described above. A preferable comonomer is lactic acid, which results in the formation of a copolymer of glycolic acid and lactic acid (PGLA).

The repeating units of glycolic acid in the PGA of the PGA composition of the present invention form essentially form a PGA homopolymer having at least 70 mass %, preferably at least 80 mass %, more preferably at least 90 mass %, even more preferably at least 95 mass %, and particularly preferably at least 98 mass % of the repeating units of glycolic acid. When the ratio of repeating units of glycolic acid is too small, the expected hydrolyzability, heat resistance, mechanical characteristics, and the like of the PGA composition of the present invention become poor. Repeating units other than the glycolic acid repeating units are used at a ratio of at most 30 mass %, preferably at most 20 mass %, more preferably at most 10 mass %, even more preferably at most 5 mass %, particularly preferably at most 2 mass %, and most preferably at most 1 mass %; and no repeating units other than glycolic acid repeating units may also be used.

In order to efficiently produce the desired high-molecular weight polymer, the PGA in the PGA composition of the present invention is preferably a PGA obtained by polymerizing from 70 to 100 mass % of a glycolide and from 30 to 0 mass % of another comonomer described above. The other comonomer may be a bimolecular cyclic monomer or a mixture of both rather than a cyclic monomer, but in order to obtain the targeted PGA composition of the present invention, a cyclic monomer is preferable. A PGA obtained by performing ring-opening polymerization on from 70 to 100 mass % of a glycolide and from 30 to 0 mass % of another cyclic monomer will be described in detail hereinafter.

(Glycolide)

A glycolide for forming a PGA by ring-opening polymerization is a bimolecular cyclic ester of glycolic acid. The production method of a glycolide is not particularly limited, but a glycolide can typically be obtained by the thermal depolymerization of a glycolic acid oligomer. Examples of methods that can be used as a glycolic acid oligomer depolymerization method include a melt depolymerization method, a solid phase depolymerization method, and a solution depolymerization method, and a glycolide obtained as a cyclic condensate of a chloroacetic acid salt may also be used. In addition, a glycolide containing glycolic acid with a maximum glycolide content of 20 mass % may be used.

The PGA in the PGA composition of the present invention may be formed by performing ring-opening polymerization on a glycolide alone, but a copolymer may also be formed by simultaneously performing ring-opening polymerization on another cyclic monomer as a copolymer component. When a copolymer is formed, a glycolide ratio of the copolymer is at least 70 mass %, preferably at least 80 mass %, more preferably at least 95 mass %, even more preferably at least 95 mass %, particularly preferably at least 98 mass %, and most preferably at least 99 mass % which is essentially a PGA homopolymer.

(Other Cyclic Monomer)

Other cyclic monomers that can be used as components to be copolymerized with the glycolide include bimolecular cyclic esters of hydroxycarboxylic acid such as lactides as well as cyclic monomers such as lactones (for example, -propiolactone, -butyrolactone, pivalolactone, □-butyrolactone, □-valerolactone, -methyl-□-valerolactone, □-caprolactone, or the like), trimethylenecarbonate, and 1,3-dioxane. A preferable other cyclic monomer is another bimolecular cyclic ester of hydroxycarboxylic acid, examples of which include L-lactic acid, D-lactic acid, □-hydroxybutyric acid, □-hydroxyisobutyric acid, □-hydroxyvaleric acid, □-hydroxycaproic acid, □-hydroxyisocaproic acid, □-hydroxyheptanoic acid, □-hydroxyoctanoic acid, □-hydroxydecanoic acid, □-hydroxymyristic acid, □-hydroxystearic acid, and alkyl-substituted products thereof. A particularly preferable other cyclic monomer is a lactide which is a bimolecular cyclic ester of lactic acid, and this may be an L-form, a D-form, a racemic form, or a mixture thereof.

The ratio of the other cyclic monomer is at most 30 mass %, preferably at most 20 mass %, more preferably at most 10 mass %, even more preferably at most 5 mass %, particularly preferably at most 2 mass %, and most preferably at most 1 mass %. When the PGA is formed from 100 mass % of a glycolide, the ratio of the other cyclic monomer is 0 mass %, and such a PGA is also included in the scope of the present invention. By performing ring-opening copolymerization on a glycolide and another cyclic monomer, it is possible to improve the molding workability by reducing the melting point (Tm, sometimes called the “crystal melting point”) of the PGA copolymer, reducing the processing temperature for producing a product such as a molded product from the PGA composition, or controlling the crystallization speed. However, when the ratio of the cyclic monomers that are used is too high, the crystallinity of the PGA copolymer that is formed is diminished, and the heat resistance, mechanical characteristics, and the like are reduced.

(Ring-Opening Polymerization Reaction)

The ring-opening polymerization or ring-opening copolymerization of a glycolide (collectively called “ring-opening (co)polymerization” hereafter) is preferably performed in the presence of a small amount of a catalyst. The catalyst is not particularly limited, but examples include tin compounds such as tin halides (for example, tin dichloride, tin tetrachloride, and the like), organic tin carboxylates (for example, tin octanoates such as tin 2-ethylhexanoate); titanium compounds such as alkoxytitanate; aluminum compounds such as alkoxyaluminum; zirconium compounds such as zirconium acetyl acetone; and antimony compounds such as antimony halide and antimony oxide. The amount of the catalyst that is used is preferably approximately from 1 to 1,000 ppm and more preferably approximately from 3 to 300 ppm in terms of mass ratio relative to the cyclic ester.

In the ring-opening (co)polymerization of the glycolide, a protic compound such as an alcohol (which may be a higher alcohol such as lauryl alcohol) or water may be used as a molecular weight adjusting agent in order to control physical properties such as the melt viscosity or molecular weight of the produced PGA. In addition, a glycolide typically contains a minute amount of water and hydroxycarboxylic acid compounds such as glycolic acids or straight-chain glycolic acid oligomers as impurities, and these compounds also act on the polymerization reaction. Therefore, the molecular weight of the product PGA can be adjusted by quantitating the concentration of these impurities as a molar concentration by means of the neutralization titration of carboxylic acid, for example, and adding an alcohol or water as a protic compound in accordance with the target molecular weight so as to control the molar concentration of the entire protic compound with respect to the glycolide. In addition, a polyhydric alcohol such as glycerin may be added to improve the physical properties.

The ring-opening (co)polymerization of the glycolide may be bulk polymerization or solution polymerization, but bulk polymerization is used in many cases. A polymerization apparatus for bulk polymerization may be selected appropriately from various apparatuses such as an extruder type, a vertical type having paddle wings, a vertical type having helical ribbon wings, an extruder or kneader horizontal type, an ampoule type, a plate type, or a tube type apparatus. In addition, various reaction vessels may be used for solution polymerization.

The polymerization temperature can be set appropriately in accordance with the intended purpose in a range of 120° C. to 300° C., which is essentially the polymerization initialization temperature. The polymerization temperature is preferably from 130 to 270° C., more preferably from 140 to 260° C., and particularly preferably from 150 to 250° C. When the polymerization temperature is too low, the molecular weight distribution of the produced PGA tends to become wide. When the polymerization temperature is too high, the produced PGA tends to be subjected to thermal decomposition. The polymerization time is in a range of 3 minutes to 50 hours and preferably from 5 minutes to 30 hours. When the polymerization time is too short, it is difficult for polymerization to progress sufficiently, which makes it impossible to realize the prescribed weight average molecular weight. When the polymerization time is too long, the produced PGA tends to be colored.

After the produced PGA is converted to a solid state, solid phase polymerization may be further performed as desired. Solid phase polymerization refers to the operation of performing heat treatment while maintaining a solid state by heating at a temperature less than the melting point of the PGA. As a result of this solid phase polymerization, low-molecular-weight components such as unreacted monomers or oligomers are volatilized and removed. Solid phase polymerization is preferably performed for from 1 to 100 hours, more preferably from 2 to 50 hours, and particularly preferably from 3 to 30 hours.

In addition, a thermal history may be provided by a process of melt-kneading the PGA in the solid state within a temperature range of at least the melting point (Tm) thereof and preferably from the melting point (Tm) +20° C. to the melting point (Tm) +100° C. so as to control the crystallinity.

(Weight Average Molecular Weight (Mw))

The weight average molecular weight (Mw) of the PGA contained in the PGA composition of the present invention is typically preferably in a range of from 70,000 to 1,000,000, more preferably in a range of from 100,000 to 800,000, even more preferably in a range of from 120,000 to 500,000, and particularly preferably in a range of from 150,000 to 400,000. The weight average molecular weight (Mw) of the PGA is determined by a gel permeation chromatography (GPC) apparatus. When the weight average molecular weight (Mw) is too low, degradation progresses quickly, which may make it difficult to achieve the purpose of the present invention, or the heat resistance or the mechanical characteristics such as strength may be insufficient. When the weight average molecular weight (Mw) is too high, it may become difficult to product the PGA composition, or the hydrolyzability or degradability may be insufficient.

(Molecular Weight Distribution (Mw/Mn))

Setting the molecular weight distribution (Mw/Mn), which is expressed as the ratio (Mw/Mn) of the weight average molecular weight (Mw) to the number average molecular weight (Mn) of the PGA contained in the PGA composition of the present invention, to in a range of 1.5 to 4.0 is preferable in that the degradation rate can be controlled by reducing the amount of polymer components in the low-molecular-weight range susceptible to degradation at an early stage or polymer components in the high-molecular-weight range with fast degradation. When the molecular weight distribution (Mw/Mn) is too broad, the degradation rate is no longer dependent on the weight average molecular weight (Mw) of the PGA, which may make it difficult to control degradation. When the molecular weight distribution (Mw/Mn) is too narrow, it may be difficult to maintain the mechanical characteristics such as the strength of the PGA composition for a prescribed period of time. The molecular weight distribution (Mw/Mn) is preferably from 1.6 to 3.7 and more preferably from 1.65 to 3.5. As in the case of the weight average molecular weight (Mw), the molecular weight distribution (Mw/Mn) is determined using a GPC analysis apparatus.

(Melting Point (Tm))

The melting point (Tm) of the PGA contained in the PGA composition of the present invention is typically from 180 to 245° C. and can be adjusted based on the weight average molecular weight (Mw), the types and content ratios of copolymerization components, and the like. The melting point (Tm) of the PGA is preferably from 190 to 240° C., more preferably from 195 to 235° C., and particularly preferably from 200 to 230° C. The melting point (Tm) of a homopolymer of the PGA is typically approximately 220° C. When the melting point (Tm) is too low, the heat resistance or the mechanical characteristics such as strength may be insufficient. When the melting point (Tm) is too high, the workability of the PGA composition may be insufficient, or it may not be possible to sufficiently control the formation of the product, which may prevent characteristics such as the hydrolyzability or biodegradability from falling within the desired ranges. The melting point (Tm) of the PGA is determined in a nitrogen atmosphere using a differential scanning calorimeter (DSC).

(Glass Transition Temperature (Tg))

The glass transition temperature (Tg) of the PGA contained in the PGA composition of the present invention is typically from 25 to 60° C., preferably from 30 to 55° C., more preferably from 32 to 52° C., and particularly preferably from 35 to 50° C. The glass transition temperature (Tg) of the PGA can be adjusted by the weight average molecular weight (Mw), the molecular weight distribution, the types and content ratios of the copolymer components, and the like. The glass transition temperature (Tg) of the PGA is determined in a nitrogen atmosphere using a differential scanning calorimeter (DSC).

[Melt Flow Rate (MFR)]

The melt flow rate (MFR) of the PGA contained in the PGA composition of the present invention is ordinarily preferably within a range of from 0.1 to 100 g/10 min, more preferably within a range of from 1 to 50 g/10 min, and even more preferably within a range of from 2 to 20 g/10 min. The MFR of the PGA is expressed as the amount of fluid flow (g) per 10 minutes measured at a temperature of 240° C. under a load of 2.16 kg. When the MFR of the PGA is too high, it may not be possible to secure molding workability depending on the production process, or the mechanical characteristics such as the strength of a product obtained from the PGA composition may be insufficient, which may prevent a PGA composition having the desired characteristics from being obtained. When the MFR of the PGA is too low, it may become difficult to mold the resulting PGA composition.

2. Inorganic Filler

The PGA composition of the present invention contains an inorganic filler in addition to a PGA. The inorganic filler is not particularly limited, and an inorganic filler of a fiber shape or a whisker shape may be used. An inorganic filler other than a fibrous or whisker-like filler may also be used, such as a sheet-like (stratified), powdered, or granular inorganic filler. In addition, inorganic fillers of various compositions may be used, such as carbon-based, metal-based, or silicon-based inorganic fillers.

Specific examples of fibrous or whisker-like inorganic fillers that may be used include inorganic fibrous fillers such as glass fibers (long fiber type or short fiber type chopped strands, mild fibers, or the like), Pan-type or pitch-type carbon fibers, graphite fibers, metal fibers such as aluminum fibers, brass fibers, or stainless steel fibers, alumina fibers, zirconia fibers, ceramic fibers, asbestos fibers, gypsum fibers, silicon carbide fibers, silica fibers, titanium oxide fibers, and rock wool; and inorganic whisker-like fillers such as potassium titanate whiskers, barium titanate whiskers, aluminum borate whiskers, silicon nitride whiskers, zinc oxide whiskers, calcium carbonate whiskers, wollastonite whiskers, and aluminum borate whiskers.

Examples of inorganic fillers other than fibrous or whisker-like fillers that may be used include silicates such as silicon oxide (silica, silica sand, or the like); talc, kaolin, mica, asbestos, aluminosilicate, and magnesium silicate; stratified silicates represented by swelling micas such as Li-type fluorine taeniolite, Na-type fluorine taeniolite, Na-type tetrasilicon fluorine mica, and Li-type tetrasilicon fluorine mica; metal oxides such as magnesium oxide, alumina, zinc oxide, zirconium oxide, titanium oxide, iron oxide, antimony oxide, tungstic acid, and vanadium; sulfates such as calcium sulfate, barium sulfate, and aluminum sulfate; hydroxides such as calcium hydroxide, magnesium hydroxide, and aluminum hydroxide; clay minerals such as montmorillonite, kaolinite, beidellite, saponite, nontronite, hectorite, sauconite, vermiculite, halloysite, kanemite, octosilicate, magadiite, kenyaite, zirconium phosphate, and titanium phosphate; stratified phosphates such as hydroxyapatite; and other sheet-like, granular, or powdered inorganic fillers such as glass beads, glass balloons, ceramic beads, glass flakes, glass powder, boron nitride, silicon carbide, calcium phosphate, carbon black, and graphite.

Of these inorganic fillers, silicon oxide, silicates, carbonates, clay minerals, inorganic fibrous fillers, or inorganic whisker-like fillers are preferable, and silica sand, silica, talc, kaolin, mica, calcium carbonate, magnesium carbonate, barium carbonate, barium sulfate, montmorillonite, glass fibers, carbon fibers, or graphite fibers are particularly preferable.

Two or more types of organic fillers may be used in combination and can be used so as to be contained in the PGA composition. For example, combinations of fibrous or whisker-like inorganic fillers and non-fibrous or non-whisker-like inorganic fillers and combinations of non-fibrous or non-whisker-like inorganic fillers are preferable. In addition, the inorganic fillers used in the present invention may also be used after the surface thereof is treated with a surface treatment agent such as a known coupling agent (for example, a silane coupling agent, a titanate coupling agent, or the like). Further, the glass fibers used in the present invention are preferably treated with a thermoplastic resin such as an ethylene/vinyl acetate copolymer or an epoxy-based, urethane-based, or acrylic coating agent or sizing agent, and an epoxy-based agent is particularly preferable. In addition, the breadth of the glass fibers is preferably from 0.1 to 1,000 μm and more preferably from 1 to 100 μm. When the breadth is too short or too long, it may not be possible to express sufficient strength. In addition, the fiber length is preferably from 0.1 to 10 mm and more preferably from 1 to 7 mm. When the fiber length is too short, it may not be possible to express sufficient strength, and when the fiber length is too long, the melt-kneading process may become difficult.

The content of the inorganic filler in the PGA composition of the present invention is an amount yielding a ratio of from 30 to 90 mass % of the PGA and from 70 to 10 mass % of the inorganic filler, preferably from 35 to 80 mass % of the PGA and from 65 to 20 mass % of the inorganic filler, and more preferably an amount yielding a ratio of from 40 to 75 mass % of the PGA and from 60 to 25 mass % of the inorganic filler. When the inorganic filler content is too small, the heat resistance or the mechanical characteristics such as strength of the PGA composition may be insufficient. When the inorganic filler content is too large, the workability of the PGA composition may be insufficient, or it may not be possible to sufficiently control the formation of the product, which may prevent characteristics such as the hydrolyzability or biodegradability from falling within the desired ranges.

3. Other Resins or Additives

The PGA composition of the present invention may further contain other biodegradable resins, other resins, or other additives as long as they do not conflict with the purpose of the present invention.

[Other Biodegradable Resins]

Examples of other biodegradable resins that may be further contained in the PGA composition of the present invention include polyhydroxyalkanoates such as polyhydroxybutylate, polyhydroxyvalerate, polyhydroxycaproate, polyhydroxyheptanoate, and poly(hydroxybutylate/hydroxyvalerate); polyesters formed from dicarboxylic acids and diols such as polyethylene succinate, polybutylene succinate, and polybutylene succinate adipate; polyether esters such as polydioxanone; aliphatic polycarbonates such as polytrimethylene carbonate; polyamino acids such as poly-□-pyrrolidone, polyasparagine, and polylysine; and copolymers or mixtures thereof, but PLA is preferable. When the PGA composition of the present invention contains another biodegradable resin, it is possible to adjust the degradability—that is, the hydrolyzability or biodegradability, the workability or the mechanical characteristics such as strength. When the PGA composition of the present invention contains a PGA and another biodegradable resin, the ratio PGA is preferably at least 70 parts by mass, more preferably at least 80 parts by mass, even more preferably 90 parts by mass, and particularly preferably at least 95 parts by mass when the total of the PGA and the other biodegradable resin is defined as 100 parts by mass.

(Other Resins)

Examples of other resins that may be further contained in the PGA composition of the present invention include polyolefin resins such as polyethylene and polypropylene; polyamide resins such as poly-L-lysine; acrylic resins; polyethers such as polyethylene glycol and polypropylene glycol; denatured polyvinyl alcohol; soft polyolefin resins such as ethylene/glycidyl methacrylate copolymers, ethylene/propylene terpolymers, and ethylene/butylene homopolymers; styrene copolymer resins; polyphenylene sulfide resins; polyether ether ketone resins; polyester resins such as polyethylene terephthalate and polybutylene terephthalate; polyacetal resins; polysulfone resins; polyphenylene ether resins; polyimide resins; polyether imide resins; cellulose esters; polyurethane resins; phenol resins; melamine resins; unsaturated polyester resins; silicone resins; and epoxy resins. Two or more types of these other resins may also be mixed and contained in the composition. The workability or the mechanical properties such as strength of the PGA composition of the present invention can be adjusted by further containing other resins together with another biodegradable resin or without containing another biodegradable resin. When the PGA composition contains the other resins, the content of the other resins is ordinarily at most 30 parts by mass, preferably at most 20 parts by mass, and more preferably at most 10 parts by mass per 100 parts by mass of the PGA, and the content may also be 5 parts by mass or lower or 1 part by mass or lower.

[Other Additives]

Examples of other additives that may be further contained in the PGA composition of the present invention are additives which are ordinarily compounded with PGA compositions such as plasticizers (polyester plasticizers, glycerin plasticizers, polyhydric carboxylic acid ester plasticizers, phosphoric acid ester plasticizers, polyalkylene glycol plasticizers, epoxy plasticizers, and the like), antioxidants, thermal stabilizers, end capping agents, UV absorbers, flame retardants (bromine flame retardants, phosphorus flame retardants, antimony compounds, melamine compounds, and the like), lubricants, waterproofing agents, water repellents, mold releasing agents, waxes, colorants such as dyes or pigments; oxygen absorbers, crystallization accelerators, nucleating agents, hydrogen ion concentration adjusting agents, and fillers other than inorganic fillers. Two or more types of these other additives may also be mixed and contained in the composition. The content of the other additives is ordinarily at most 10 parts by mass and preferably at most 5 parts by mass per 100 parts by mass of the PGA, and the content may also be 1 part by mass or lower.

[End-Capping Agent]

Of these additives, a carboxyl group end-capping agent or a hydroxyl group end-capping agent is blended into the PGA composition, in particular, the degradability—in particular, the hydrolyzability—of the PGA composition can be controlled, and the storability of the PGA composition can be improved. That is, by blending a carboxyl group end-capping agent or a hydroxyl group end-capping agent into the composition, the unanticipated degradation of the resulting PGA composition during storage until use in molding or another process can be suppressed, and which makes it possible to suppress decreases in molecular weight and to adjust the speed of hydrolysis or biodegradation of the PGA composition. As an end-capping agent, it is possible to use a compound known as a water resistance improving agent for a PGA having a carboxyl group end-capping action or a hydroxyl group end-capping action. A carboxyl group end-capping agent is preferable as an end-capping agent from the perspective of the balance of the hydrolyzability or biodegradability and the hydrolysis resistance during storage. Examples of carboxyl group end-capping agents include carbodiimide compounds such as N,N′-2,6-diisopropyl phenyl carbodiimide; oxazoline compounds such as 2,2′-m-phenylene bis(2-oxazoline), 2,2′-p-phenylene bis(2-oxazoline), 2-phenyl-2-oxazoline, and styrene-isopropenyl-2-oxazoline; oxazine compounds such as 2-methoxy-5,6-dihydro-4H-1,3-oxazine; epoxy compounds such as N-glycidyl phthalimide, cyclohexene oxide, and tris(2,3-epoxypropyl)isocyanurate; and the like. Of these carboxyl group end-capping agents, carbodiimide compounds are preferable. Any of aromatic, alicylic, and aliphatic carbodiimide compounds can be used, but aromatic carbodiimide compounds are particularly preferable, and compounds with high purity, in particular, provide a water resistance improving effect during storage. In addition, diketene compounds, isocyanates, and the like can be used as hydroxyl end-capping agents. The carboxyl end-capping agent or hydroxyl end-capping agent is typically used at a ratio of 0.01 to 5 parts by mass, preferably from 0.05 to 3 parts by mass, and more preferably from 0.1 to 1 part by mass per 100 parts by mass of the PGA.

In addition, when the PGA composition contains a thermal stabilizer, the heat deterioration at the time of molding or the like can be suppressed, and the long-term storability of the PGA composition improves, which is more preferable. Examples of thermal stabilizers include phosphoric acid esters having a pentaerythritol skeleton structure such as cyclic neopentane tetraiyl bis(2,6-di-tert-butyl-4-methylphenyl)phosphite, cyclic neopentane tetrayl bis(2,4-di-tert-butylphenyl)phosphite, and cyclic neopentane tetrayl bis(octadecyl)phosphite; alkyl phosphate esters or alkyl phosphite esters having an alkyl group with preferably from 8 to 24 carbon atoms such as mono- or di-stearyl acid phosphates or mixtures thereof [a known commercially available product is a mixture of approximately 50 mass % of monostearyl phosphate and approximately 50 mass % of distearyl phosphate (trade name “AX-71” made by ADEKA Co., Ltd.)]; carbonates such as calcium carbonate and strontium carbonate (which may also be contained as inorganic fillers); hydrazine compounds typically known as polymerization catalyst deactivators having —CONHNH—CO-units such as bis[2-(2-hydroxybenzoyl)hydrazine]dodecanoic acid and N,N′-bis[3-(3,5-di-t-butyl-4-hydroxyphenyl)propionyl]hydrazine; triazole compounds such as 3-(N-salicyloyl)amino-1,2,4-triazole; and triazine compounds. These thermal stabilizers may each be used alone or in a combination of two or more types thereof. The thermal stabilizer is typically used at a ratio of at most 3 parts by mass, preferably from 0.001 to 1 part by mass, more preferably from 0.005 to 0.5 parts by mass, and particularly preferably from 0.01 to 0.1 parts by mass (100 to 1,000 ppm), per 100 parts by mass of the PGA.

4. Polyglycolic Acid Resin Composition

The PGA composition of the present invention is a PGA composition containing from 30 to 90 mass % of a PGA and from 70 to 10 mass % of an inorganic filler, wherein the percentage of mass loss of the polyglycolic acid resin after immersion in water for 3 hours at a temperature of 120° C. is at least 20%, and the deflection temperature under load is 120° C. or higher. The PGA composition of the present invention may be of any shape or form such as a raw material for molding such as a pellet, strand, or powder (including melt-mixed compositions and compositions obtained by melt-kneading using an extruder as described below), a sheet, a film, an extrusion-molded product, an injection-molded product, a compression-molded product, a blow-molded product, or a laminate or other composite thereof.

[Percentage of Mass Loss of the Polyglycolic Acid Resin After Immersion In Water For 3 hours at 120° C.]

The percentage of mass loss of the PGA in the PGA composition of the present invention after immersion in water for 3 hours at 120° C. (sometimes called the “percentage of mass loss after 3 hours at 120° C.”) is at least 20%, preferably at least 23%, more preferably at least 25%, and even more preferably at least 30%. Since the percentage of mass loss of the PGA of the present invention after 3 hours at 120° C. is at least 20% and more preferably at least 25%, the composition may have excellent moldability and mechanical characteristics as well as excellent heat resistance and hydrolyzability. When the percentage of mass loss of the PGA composition after 3 hours at 120° C. is less than 20%, the hydrolyzability and biodegradability may be insufficient.

The percentage of mass loss of the PGA composition after 3 hours at 120° C. is measured by the following method. Specifically, an evaluation test specimen with a dumbbell shape (the dumbbell shape specifications are in accordance with ISO 294) is created by injection molding, and the mass of the evaluation test specimen is measured. The mass of the PGA in the evaluation test specimen (called the “pre-test PGA mass” hereafter) is calculated with reference to the content ratio of the inorganic filler. Next, purified water and the evaluation test specimen are enclosed in a bag made of a barrier packaging material, and the bag is sealed shut. The bag containing purified water and the evaluation test specimen is charged into a retort oven adjusted to a temperature of 120° C., and the evaluation test specimen is retrieved after three hours. After the retrieved evaluation test specimen is subjected to cold air blowing and vacuum drying to remove the water content, the mass of the evaluation test specimen is measured, and the mass of the PGA in the evaluation test specimen after the test (called the “post-test PGA mass” hereafter) is measured. The percentage of mass loss of the PGA composition after 3 hours at 120° C. is calculated from the following calculation formula.

Calculation formula:

percentage of mass loss after 3 hours at 120° (%)=(pre-test PGA mass−post-test PGA mass)/pre-test PGA mass×100

[Deflection Temperature Under Load]

The deflection temperature under load of the PGA composition of the present invention is at least 120° C., preferably at least 140° C., more preferably at least 150° C., and even more preferably at least 160° C. Since the deflection temperature under load of the PGA composition of the present invention is at least 120° C., the composition may have excellent moldability and mechanical characteristics as well as excellent heat resistance and hydrolyzability. When the deflection temperature under load of the PGA composition of the present invention is less than 120° C., the heat resistance, hydrolyzability, and biodegradability may be insufficient. The deflection temperature under load of the PGA composition of the present invention was measured in accordance with ISO 75 (flatwise method with a bending stress: 1.80 MPa, span: 64 mm, and heating rate: 120° C./h).

[Melt Flow Rate (MFR)]

The melt flow rate (MFR) of the PGA contained in the PGA composition of the present invention is ordinarily preferably within a range of from 0.1 to 100 g/10 min, more preferably within a range of from 1 to 80 g/10 min, and even more preferably within a range of from 2 to 20 g/10 min. The MFR of the PGA composition is expressed as the amount of fluid flow (g) per 10 minutes measured at a temperature of 240° C. under a load of 2.16 kg. When the MFR of the PGA composition is too high, it may not be possible to secure molding workability depending on the production process, or the mechanical characteristics such as the strength of a product obtained from the PGA composition may be insufficient. When the MFR of the PGA composition is too low, it may become difficult to mold the PGA composition, which may prevent a product obtained from a PGA composition having the desired characteristics from being obtained.

[Mechanical Characteristics]

The PGA composition of the present invention has an excellent balance of mechanical characteristics. Specifically, the following conditions required as mechanical properties can be met:

(a) the Charpy impact strength (according to ISO 179) is at least 3 KJ/m², preferably at least 4 KJ/m², and more preferably at least 5 KJ/m²;

(b) the tensile strength (according to ISO 527) is at least 50 MPa and preferably at least 70 MPa;

(c) the elasticity (according to ISO 527) is at least 1% and preferably at least 1.5%;

(d) the bending strength (according to ISO 178) is at least 100 MPa, preferably at least 110 MPa, and more preferably at least 120 MPa; and

(e) the bending modulus of elasticity (according to ISO 178) is at least 8 GPa, preferably at least 10 GPa, and more preferably at least 15 GPa.

[Biodegradability]

The PGA composition of the present invention has excellent biodegradability. The biodegradability of the PGA composition is evaluated by the steps of burying the pre-test evaluation test specimen used in the measurement of the percentage of mass loss after 3 days at 120° C. in soil maintained at a temperature of 60° C. for 2 months, digging up the specimen, and visually observing any degradation in shape. It can be assessed that there is biodegradability if the specimen is degraded to an extent that the original shape is unrecognizable.

5. Method For Producing Polyglycolic Acid Resin Composition

The method for producing the PGA composition of the present invention is not particularly limited as long as it is possible to obtain a PGA composition containing from 30 to 90 mass % of a PGA and from 70 to 10 mass % of an inorganic filler, wherein the percentage of mass loss of the polyglycolic acid resin after immersion in water for 3 hours at a temperature of 120° C. is at least 20%, and the deflection temperature under load is 120° C. or higher. The method for producing the PGA preferably includes a step of melt-kneading the PGA and an inorganic filler using an extruder. Further, a PGA composition with a large inorganic filler content can be easily produced with a method for producing a PGA composition in which an extruder provided with a main feed port and a side feed port is used, wherein PGA is supplied from the main feed port and the inorganic filler is supplied from at least the side feed port to the extruder; and, in particular, a method for producing a PGA composition in which the inorganic filler is supplied to the extruder from the main feed port and the side feed port, which is preferable.

A step of melt-kneading using an extruder refers to a step of supplying a raw material containing from 30 to 90 mass % of a PGA as a material for forming a PGA composition and from 70 to 10 mass % of an inorganic filler to an extruder provided with a screw and a cylinder and having a melt-kneading function, heating and melting the raw material while kneading the raw material based on external heating and shear heating, extruding the material into a shape such a rod shape, and if desired, cutting the material into pellets of with a length of approximately a prescribed number of mm so as to form a PGA composition having a prescribed material composition. Since the method for producing the PGA composition of the present invention is a method for producing a PGA composition including a step of melt-kneading using an extruder and, preferably, a step of producing a PGA composition including a step of melt-kneading using a twin screw extruder having two screws, the PGA and the inorganic filler are mixed uniformly in a short amount of time. As a result, the stability and production efficiency of the product of the PGA composition are good, and the composition may thereby have excellent moldability, mechanical characteristics, heat resistance, hydrolyzability, and biodegradability. In particular, a PGA composition obtained by a method for producing a PGA composition including a step of melt-kneading using a twin screw extruder has good inorganic filler dispersion/distribution efficiency and can be formed into a product of a PGA composition having various forms/shapes such as a sheet, a film, or an injection-molded product, and a product made of the PGA composition having excellent moldability, mechanical characteristics, heat resistance, hydrolyzability, and biodegradability can thus be obtained, which is preferable.

In addition, when the melt-kneading step is performed by using an extruder provided with a main feed port and a side feed port as an extruder and supplying the PGA from the main feed port and the inorganic filler from at least the side feed port to the extruder, or more preferably, by supplying the inorganic filler to the extruder, a PGA composition with a large inorganic filler content can be easily produced.

An extruder provided with a main feed port and a side feed port is an extruder which is provided with both a main feed port for supplying most of the material for forming the PGA composition such as a PGA (ordinarily in the form of a solid) to the extruder at a position on the screw driver part side of the extruder, and a side feed port for supplying part of the material for forming the PGA composition to the extruder at a position in the middle of the main feed port and an extrusion port (nozzle) on the tip side of the screw of the extruder. With respect to the cylinder length (L) of the extruder, the side feed port can ordinarily be provided from 0.2 to 0.9 L, preferably from 0.4 to 0.8 L, and more preferably from 0.5 to 0.75 L from the screw driver part side.

The supply of the PGA and the inorganic filler to the extruder from the main feed port and/or the side feed port can itself be achieved by a known method and mechanism. For example, a method in which the materials are supplied to the extruder via a hopper installed on the main feed port and/or the side feed port may be used, or a method in which the materials are supplied to the extruder via a feeder or an extruder installed on the main feed port and/or the side feed port may be used.

As described above, the extruder provided with a screw and a cylinder and having a melt-kneading function heats, melts, and kneads the raw material based on external heating and shear heating. Most of the material for forming the PGA composition that is supplied from the main feed port—the PGA, in particular—is in a solid form, and after the material is heated and melted based on external heating and shear heating, it is sent to the extrusion port (nozzle) in a molten fluid state. On the other hand, the part of the material for forming the PGA composition supplied from the side flow part—the inorganic filler, in particular—is supplied to the extruder in a state in which most of the material for forming the PGA composition supplied from the main feed port is already heated and melted to form a molten fluid state, so the melt-kneading of the PGA and the inorganic filler is performed as the materials are extruded from the extrusion port (nozzle) over a relatively short retention time in the extruder. Accordingly, in the method for producing a PGA composition according to the present invention, the thermal history such as the shear heat generation or the shearing force applied to the inorganic filler contained in the PGA composition can be adjusted by performing a step of supplying the inorganic filler to the extruder from the side feed port or from the main feed port and the side feed port and then melt-kneading the inorganic filler. As a result, the heat deterioration, destruction, damage, or the like of the inorganic filler can be reduced or eliminated, which yields a particularly desirable effect when fibrous or whisker-like inorganic fillers are used.

In the method for producing a PGA composition according to the present invention including a step of melt-kneading a PGA and an inorganic filler using an extruder, the supply of the inorganic filler to the extruder can be achieved with any of the following supply methods: i) supplying from the main feed port and the side feed port, ii) supplying from the side feed port, or iii) supplying from the main feed port. However, a preferable supplying method is i) supplying from the main feed port and the side feed port or ii) supplying from the side feed port, and a particularly preferable supply method is i) supplying from the main feed port and the side feed port. That is, the ratio of the inorganic filler resulting from each supply method (expressed as mass %) may be within a range of from 100:0 to 0:100 but is preferably within a range of from 100:0 to 20:80, more preferably from 90:10 to 30:70, and even more preferably from 80:20 to 40:60 in terms of the amount supplied from the side feed port versus the amount supplied from the main feed port.

### EXAMPLES

The PGA composition of the present invention will be described in further detail hereinafter using working examples and comparative examples. The present invention is not limited to these working examples. The characteristics of the PGA and the PGA composition were measured with the following methods.

(Weight Average Molecular Weight (Mw) and Molecular Weight Distribution (Mw/Mn))

The weight average molecular weight (Mw) of the PGA was obtained using a GPC analysis apparatus. Specifically, after 10 mg of a PGA sample was dissolved in hexafluoroisopropanol (HFIP) in which sodium trifluoroacetate was dissolved at a concentration of 5 mM to form 10 mL, the solution was filtered with a membrane filter to obtain a sample solution. 10 μL of this sample solution was injected into the GPC analysis apparatus, and the weight average molecular weight (Mw) and the molecular weight distribution (Mw/Mn) were determined from the results found by measuring the molecular weight under the following measurement conditions.

<GPC Measurement Conditions>

Apparatus: GPC104 manufactured by Showa Denko K.K.

Columns: two HFIP-806M columns (connected in series)+one HFIP-LG precolumn manufactured by Showa Denko K.K.

Column temperature: 40° C.

Eluent: HFIP solution in which sodium trifluoroacetate was dissolved at a concentration of 5 mM

Detector: differential refractometer

Molecular weight calibration: Calibration curve data for the molecular weight was created using five types of methyl polymethacrylate (manufactured by Polymer Laboratories Ltd.) with different standard molecular weights.

(Melting Point (Tm) and Glass Transition Temperature (Tg))

The melting point (Tm) and the glass transition temperature (Tg) of the PGA were determined in a nitrogen atmosphere using a differential scanning calorimeter (DSC; TC-15 manufactured by Mettler-Toledo International Inc.).

[Percentage of Mass Loss After 3 Hours At 120° C.]

The percentage of mass loss of the PGA composition after 3 hours at 120° C. was measured by the following method. Specifically, an evaluation test specimen with a dumbbell shape (the dumbbell shape specifications were in accordance with ISO 294) was created by injection molding, and the mass of the evaluation test specimen is measured. The mass of the PGA in the evaluation test specimen (“pre-test PGA mass”) was calculated with reference to the content ratio of the inorganic filler. Next, purified water and the evaluation test specimen were enclosed in a bag made of a barrier packaging material, and the bag was sealed. The bag containing purified water and the evaluation test specimen was charged into a retort oven adjusted to a temperature of 120° C., and the evaluation test specimen was retrieved after three hours. After the retrieved evaluation test specimen was subjected to cold air blowing and vacuum drying to remove the water content, the mass of the evaluation test specimen was measured, and the mass of the PGA in the evaluation test specimen after the test (called the “post-test PGA mass” hereafter) was measured. The percentage of mass loss of the PGA composition after 3 hours at 120° C. was calculated from the following calculation formula.

Calculation formula:

percentage of mass loss after 3 hours at 120° C. (%)=(pre-test PGA mass−post-test PGA mass)/pre-test PGA mass×100

[Deflection Temperature Under Load]

The deflection temperature under load of the PGA composition of the present invention was measured in accordance with ISO 75 (flatwise method with a bending stress: 1.80 MPa, span: 64 mm, and heating rate: 120° C./h).

[Melt Flow Rate (MFR)]

The melt flow rate (MFR) of the PGA and the PGA composition was measured as the amount of fluid flow (g) per 10 minutes measured at a temperature of 240° C. under a load of 2.16 kg.

[Charpy Impact Strength]

The Charpy impact strength of the PGA composition was measured in accordance with ISO 179.

[Tensile Strength and Elasticity]

The tensile strength and elasticity of the PGA composition were measured in accordance with ISO 527.

[Bending Strength and Bending Modulus of Elasticity]

The bending strength and bending modulus of elasticity of the PGA composition were measured in accordance with ISO 178.

[Biodegradability]

The biodegradability of the PGA composition was evaluated by the steps of burying the evaluation test specimen used in the measurement of the percentage of mass loss after 3 days at 120° C. in soil maintained at a temperature of 60° C. for 2 months, digging up the specimen, and visually observing any degradation in shape. It was assessed that there was biodegradability when the specimen was degraded to an extent that the original shape was unrecognizable.

### Working Example 1

PGA pellets (made by Kureha Co., Ltd., Mw: 200,000, Mw/Mn: 2.2, MFR: 10 g/10min, Tg: 43° C., Tm: 220° C., diameter: 3 mm×length: 3 mm) were supplied from a main feed port to a twin screw extruder (made by Nippon Placon Co., Ltd.) with a diameter (D) of 48 mm and melted at a temperature of from 200 to 240° C. In addition, silica sand [made by JFE Minerals Co., Ltd., Nikko Silica Sand (registered trademark) No. 8] was supplied to the twin screw extruder from a side feed port [provided at a position approximately 0.6 L from the screw driver part side with respect to the cylinder length (L) of the twin screw extruder], and the PGA and the silica sand were melt-kneaded at a temperature of from 240 to 250° C. The content ratio of the PGA and the silica sand in the PGA composition was 50 mass %:50 mass %. After the step of melt-kneading using an extruder, the PGA and the silica sand were extruded from an extrusion die having a nozzle with a diameter of 4 mm, and after the composition was cooled with water, the water content was sufficiently removed by air. The composition was then cut with a strand cutter to obtain a pellet-shaped PGA composition with a diameter of 3 mm and a length of 3 mm (also sometimes called a “compound of the PGA and silica sand”). After the pellet-shaped PGA composition was sufficiently dried, the composition was supplied to an injection molding machine (made by Toshiba Machine Co., Ltd., IS75E) to create an evaluation test specimen with a dumbbell shape (the dumbbell shape specifications were in accordance with ISO 294). The results of measuring the percentage of mass loss after 3 hours at 120° C., the deflection temperature under load, the MFR, the Charpy impact strength, the tensile strength and elasticity, the bending strength and bending modulus of elasticity of the created evaluation test specimen are shown in Table 1. In addition, when the evaluation specimen of the PGA composition was buried for 2 months in soil maintained at a temperature of 60° C. and was then dug up and visually inspected, the evaluation test specimen had completely degraded, so it was assessed that the PGA composition has biodegradability.

### Working Example 2

An evaluation test specimen was created in the same manner as in Working Example 1 with the exception of changing the inorganic filler to talc [made by Nippon talc Co., Ltd., MICROACE (registered trademark) L-1 (average particle size: 5 μm, water content: 0.2%, apparent density: 0.15 g/cm³), sometimes called “talc 1” hereafter] and changing the content ratio of the PGA and talc to 70 mass %:30 mass %. The results of measuring the percentage of mass loss after 3 hours at 120° C., the deflection temperature under load, the MFR, the Charpy impact strength, the tensile strength and elasticity, the bending strength and bending modulus of elasticity of the created evaluation test specimen are shown in Table 1. In addition, when the evaluation specimen of the PGA composition was buried for 2 months in soil maintained at a temperature of 60° C. and was then dug up and visually inspected, the evaluation test specimen had completely degraded, so it was assessed that the PGA composition has biodegradability.

### Working Example 3

An evaluation test specimen was created in the same manner as in Working Example 1 with the exception of changing the inorganic filler to talc [made by Nippon talc Co., Ltd., SHIMUGON (average particle size: 8 μm, water content: 0.2%, apparent density: 0.29 g/cm³), sometimes called “talc 2” hereafter] and changing the method of supplying the inorganic filler (talc 2) to the twin screw extruder to a method of respectively supplying 30% (mass ratio) of the total amount of talc from the main feed port and 70% (mass ratio) of the total amount of talc from the side feed port. The results of measuring the percentage of mass loss after 3 hours at 120° C., the deflection temperature under load, the MFR, the Charpy impact strength, the tensile strength and elasticity, the bending strength and bending modulus of elasticity of the created evaluation test specimen are shown in Table 1. In addition, when the evaluation specimen of the PGA composition was buried for 2 months in soil maintained at a temperature of 60° C. and was then dug up and visually inspected, the evaluation test specimen had completely degraded, so it was assessed that the PGA composition has biodegradability.

### Comparative Example 1

An evaluation test specimen was created in the same manner as in Working Example 1 with the exception of supplying only the PGA pellets to the secondary extruder without using an inorganic filler. The results of measuring the percentage of mass loss after 3 hours at 120° C., the deflection temperature under load, the MFR, the Charpy impact strength, the tensile strength and elasticity, the bending strength and bending modulus of elasticity of the created evaluation test specimen are shown in Table 1. In addition, when the evaluation specimen of the PGA composition was buried for 2 months in soil maintained at a temperature of 60° C. and was then dug up and visually inspected, the evaluation test specimen had completely degraded.

### Comparative Example 2

An evaluation test specimen of a PLA (not containing an inorganic filler) was created in the same manner as in Comparative Example 1 with the exception of changing the PGA pellets to PLA pellets (3052D made by Nature Works Co., Ltd.). The results of measuring the percentage of mass loss after 3 hours at 120° C., the deflection temperature under load, the MFR, the Charpy impact strength, the tensile strength and elasticity, the bending strength and bending modulus of elasticity of the created evaluation test specimen are shown in Table 1. In addition, when the evaluation specimen of the PGA composition was buried for 2 months in soil maintained at a temperature of 60° C. and was then dug up and visually inspected, the shape of the evaluation test specimen was roughly maintained.

### Comparative Example 3

An evaluation test specimen of a PLA composition was created in the same manner as in Working Example 3 with the exception of changing the PGA pellets to the PLA pellets. The results of measuring the percentage of mass loss after 3 hours at 120° C., the deflection temperature under load, the MFR, the Charpy impact strength, the tensile strength and elasticity, the bending strength and bending modulus of elasticity of the created evaluation test specimen are shown in Table 1. In addition, when the evaluation specimen of the PGA composition was buried for 2 months in soil maintained at a temperature of 60° C. and was then dug up and visually inspected, the shape of the evaluation test specimen was roughly maintained.

TABLE 1

| | | Working | Working | Working | | | |
|---|---|---|---|---|---|---|---|
| | | Example | Example | Example | Comparative | Comparative | Comparative |
| | | 1 | 2 | 3 | Example 1 | Example 2 | Example 3 |
| Resin | | PGA | PGA | PGA | PGA | PLA | PLA |
| Inorganic filler | | Silica | Talc 1 | Talc 2 | — | — | Talc 2 |
| | | sand | | | | | |
| Inorganic filler | Mass | 50 | 30 | 50 | 0 | 0 | 50 |
| content | % | | | | | | |
| Percentage of | % | 26.6 | 50.5 | 33.0 | 50.7 | 5.1 | 4.5 |
| mass loss after 3 | | | | | | | |
| days at 120° C. | | | | | | | |
| Deflection | ° C. | 185 | 183 | 189 | 168 | 55 | 84 |
| temperature | | | | | | | |
| under load | | | | | | | |
| MFR | g/10 | 8.4 | 15.5 | 65.8 | 8.0 | 14.0 | 17.6 |
| | min | | | | | | |
| Charpy impact | KJ/m² | 6.7 | 26.6 | 9.9 | 2.2 | 16.0 | 3.7 |
| strength | | | | | | | |
| Tensile strength | MPa | 55 | 106 | 76 | 109 | 62 | 48 |
| Elasticity | % | 1.3 | 2.8 | 1.8 | 2.1 | 3.5 | 2.3 |
| Bending | MPa | | | | | | |
| strength | | 110 | 181 | 140 | 192 | 108 | 91 |
| Bending | GPa | 14.8 | 15.4 | 19.6 | 6.6 | 3.6 | 5.1 |
| modulus of | | | | | | | |
| elasticity | | | | | | | |

It can be seen from Table 1 that the PGA compositions of Working Examples 1 to 3, which contain from 30 to 90 mass % of a PGA and from 70 to 10 mass % of an inorganic filler, wherein the percentage of mass loss of the polyglycolic acid resin after immersion in water for 3 hours at a temperature of 120° C. is at least 20%, and the deflection temperature under load is 120° C. or higher, satisfy all of the requirements of having a Charpy impact strength of at least 3 KJ/m², a tensile strength of at least 50 MPa, an elasticity of at least 1%, a bending strength of at least 100 MPa, and a bending modulus of elasticity of at least 8 GPa and are therefore compounds having balanced mechanical characteristics.

In addition, it was inferred that the PGA compositions of Working Examples 1 to 3 have the excellent characteristics described above as a result of good dispersibility of the PGA and the inorganic filler due to the fact that the PGA compositions are obtained by a method for producing a PGA composition including a step of melting and compounding the PGA and the inorganic filler using an extruder. In particular, the PGA composition of Working Example 3, which was obtained by a method for producing a PGA composition in which the inorganic filler was supplied to the extruder from the main feed port and the side feed port, exhibited excellent balanced results with regard to the Charpy impact strength, the tensile strength and elasticity, and the bending strength and bending modulus of elasticity in spite of being a PGA composition containing an inorganic filler at an extremely large ratio of 50 mass %. Moreover, it was inferred that the dispersibility of the PGA and the inorganic filler was even better since the percentage of mass loss after 3 hours at 120° C. was 33% higher than the percentage of mass loss after 3 hours at 120° C. of the PGA composition of Working Example 1, which also had an inorganic filler content ratio of 50 mass %.

In contrast, the PGA of Comparative Example 1, which did not contain an inorganic filler, had a small Charpy impact strength of 2 KJ/m² and a small bending modulus of elasticity of 6.6 GPa, and it was thus clear that the PGA did not have an excellent balance of mechanical characteristics.

In addition, it was clear that the PLA of Comparative Example 2, which did not contain an inorganic filler, did not have a good balance of mechanical characteristics due to the results that the percentage of mass loss after 3 hours at 120° C. was only 5.1% and the deflection temperature under load was only 55° C., and the fact that the hydrolyzability and heat resistance were insufficient, the biodegradability was insufficient, and the bending modulus of elasticity was extremely small at 3.6 GPa.

Further, it was clear that the PLA composition of Comparative Example 3, which contained talc 2 at a ratio of 50 mass % as an inorganic filler, did not have excellent mechanical characteristics due to the results that the percentage of mass loss after 3 hours at 120° C. was only 4.5% and the deflection temperature under load was only 84° C., and the fact that the hydrolyzability and heat resistance were insufficient, the biodegradability was insufficient, and the tensile strength, bending strength, and bending modulus of elasticity all demonstrated small values of 48 MPa, 91 MPa, and 5.1 GPa, respectively.

### INDUSTRIAL APPLICABILITY

The present invention can provide a PGA composition containing from 30 to 90 mass % of a PGA and from 70 to 10 mass % of an in organic filler, wherein the percentage of mass loss of the polyglycolic acid resin after immersion in water for 3 hours at a temperature of 120° C. is at least 20%, and the deflection temperature under load is 120° C. or higher. This yields the effect of providing a PGA composition that can be used as a molding material in a general-purpose resin molding method, a packing material for food products or other products, an easily compostable packaging material with a small environmental burden, and a material for forming an oil and gas drilling downhole tool or a member thereof that can be left in the ground to degrade after use by utilizing the strength and degradability thereof, the composition containing PGA serving as a biodegradable resin having excellent moldability and mechanical characteristics as well as excellent heat resistance and hydrolyzability, and a downhole tool or member thereof formed from the PGA composition, so the industrial applicability of the composition is high.

In addition, the present invention is a method for producing the PGA composition including a step for melt-kneading a PGA and an inorganic filler using an extruder, which yields the effect that the PGA composition can be produced easily, so the industrial applicability of the method is high.

1. A polyglycolic acid resin composition containing from 30 to 90 mass % of a polyglycolic acid and from 70 to 10 mass % of an inorganic filler, wherein the percentage of mass loss of the polyglycolic acid resin after immersion in water for 3 hours at a temperature of 120° C. is at least 20%, and the deflection temperature under load is 120° C. or higher.

2. The polyglycolic acid resin composition according to claim 1 further containing another biodegradable resin.

3. The polyglycolic acid resin composition according to claim 2, wherein the other biodegradable resin is a polylactic acid resin.

4. The polyglycolic acid resin composition according to claim 2, wherein the amount of the polyglycolic acid is at least 70 parts by mass when the total of the polyglycolic acid and the other biodegradable resin is defined as 100 parts by mass.

5. The polyglycolic acid resin composition according to claim 1, wherein the inorganic filler is at least one type selected from silicon oxide, silicates, carbonates, sulfates, clay minerals, inorganic fibrous fillers, and inorganic whisker-like fillers.

6. The polyglycolic acid resin composition according to claim 1 containing two or more types of inorganic fillers.

7. The polyglycolic acid resin composition according to claim 1, wherein the composition is for a downhole tool or a member thereof.

8. A method for producing the polyglycolic acid resin composition described in claim 1, the method including a step of melt-kneading a polyglycolic acid and an inorganic filler using an extruder.

9. The method for producing a polyglycolic acid resin composition according to claim 8, wherein an extruder provided with a main feed port and a side feed port is used, and the polyglycolic acid is supplied from the main feed port and the inorganic filler is supplied from at least the side feed port to the extruder.

10. The method for producing a polyglycolic acid resin composition according to claim 9, wherein the inorganic filler is supplied to the extruder from the main feed port and the side feed port.

11. A downhole tool or a member thereof formed from the polyglycolic acid resin composition described in claim 1.
